(19) United States
(12) Patent Application Publication
(10) Pub. No.: US 2018/0244270 A1
(43) Pub. Date: Aug. 30, 2018

(54) SPEED CONTROL OF A MOTOR VEHICLE

(71) Applicant: ZF Friedrichshafen AG, Friedrichshafen (DE)

(72) Inventor: Cosmin TUDOSIE, Friedrichshafen (DE)

(73) Assignee: ZF Friedrichshafen AG, Friedrichshafen (DE)

(21) Appl. No.: 15/758,500

(22) PCT Filed: Aug. 24, 2016
(86) PCT No.: PCT/EP2016/069931

§ 371 Date: Mar. 8, 2018

(30) Foreign Application Priority Data
Sep. 17, 2015 (DE) 10 2015 217 801.3

(51) Int. Cl. B60W 30/14

(52) U.S. Cl. CPC B60W 30/143; B60W 2720/10; B60W 2710/10; B60W 2540/00

(57) ABSTRACT

A method for controlling a motor vehicle (100) including the steps of: identifying a route segment (305) to be covered; detecting a driver's wish that indicates a desired average speed (310) while traveling along the route segment (305); determining a speed variation curve (215) for the route segment (305) as a function of the driver's wish in such manner that the average speed (310) corresponds at least to the driver's wish and an energy consumption of the motor vehicle (100) for covering the route segment (305) is minimized as much as possible; and controlling the speed (310) of the motor vehicle (100) along the route segment (305) on the basis of the speed variation curve (215) determined.

This application is a National Stage completion of PCT/EP2016/069931 filed Aug. 24, 2016, which claims priority from German patent application Ser. No. 10 2015 217 801.3 filed Sep. 17, 2015.

### FIELD OF THE INVENTION

The invention relates to a method for controlling the speed of a motor vehicle. In particular the invention relates to a speed control method that optimizes fuel consumption.

### BACKGROUND OF THE INVENTION

A longitudinal control of a motor vehicle usually controls a drive motor of the motor vehicle in such manner that a predetermined speed is maintained. In one embodiment, in addition a distance from a motor vehicle driving ahead is monitored and if necessary the speed is adapted in order to keep that distance above a predetermined threshold value.

DE 10 2005 045 891 B3 proposes that the speed of a motor vehicle should be controlled between predetermined minimum and maximum speed values in such manner that an internal combustion engine driving the motor vehicle operates in a manner as favorable as possible for its fuel consumption.

### SUMMARY OF THE INVENTION

The purpose of the present invention is to provide an even better technique for the speed control of a motor vehicle. The invention achieves that objective by virtue of the objects of the independent claims. Preferred embodiments are described in the subordinate claims.

A method for controlling a motor vehicle comprises the steps of identifying a route segment along which the vehicle is to travel, detecting a driver's wish that indicates a desired average speed while traveling along the route segment, determining a speed variation curve for the route segment as a function of the driver's wish in such manner that the average speed corresponds at least to the driver's wish and the energy consumption of the motor vehicle while traveling along the route segment is minimized as much as possible, and controlling the speed of the motor vehicle on the route segment on the basis of the speed variation curve determined.

In particular the driver's wish can include a specification that applies to a plurality of route segments and in particular all the route segments of a travel route. It is preferable for these specifications to be produced not by conventional means such as an accelerator pedal but rather, for example, as an adjustment setting that can be made in predetermined steps such as a low, medium or high average speed. This setting is not usually changed while traveling along the route segment. The actual speed control of the motor vehicle is then carried out by the method described, so that the driver no longer has to influence the longitudinal regulation (speed or acceleration control) of the motor vehicle.

The method is particularly advantageous in combination with an autonomous control system of the motor vehicle with which it can be combined or in which it can be integrated. Even in a motor vehicle in which the driver only steers and no longer has to continually influence the speed actively, the method can be used to good effect, for example as a driver's assistance means.

The speed variation curve can at times deviate from the desired average speed. As part of the specification advantageous operating points of the motor vehicle or its drive motor can be controlled better in order to minimize the consumption while abiding by the driver's wish. In particular, a performance characteristic of a drive motor can be followed in a predictable manner. During this, particular attention can be paid to the fact that an intervention to change an operating point of the motor vehicle can itself entail a certain energy consumption. Accordingly, the invention is based on the idea of balancing the energy consumption required for changing the operating condition against an expected reduction of the consumption after the change. In a further embodiment the driver can also express a wish to cover the route segment at a maximum average speed, and in that case the speed variation curve is determined such that the driver's specification is complied with as far as possible while at the same time keeping the energy consumption as low as possible.

The speed variation curve can be controlled in that an acceleration of the drive motor takes place as a function of an applicable driving resistance. During this, other, external influencing factors as well, such as a tail wind or a head wind, can also be taken into account. Preferably, information on board the motor vehicle in the form of ADASIS (Advanced Driver Assistance Systems Interface Specifications) data are evaluated, for example in order to determine the driving resistance along the current or an imminent route segment. For this a current determination or an expected value can be processed, which for example can be determined on the basis of known starting and destination points by means of map data (topology of a route segment).

The driver's wish and the driving resistance are the main factors that influence the determination of the speed variation curve; however, other influences such as the flow of traffic, the loading of the vehicle or the condition of the ground can also be taken into account. Further influences considered can for example include the weather (fog, rain, ice, etc.). If on a route segment a predetermined speed variation curve cannot be realized, for example because there is a traffic hold-up, then the speed variation curve can be adapted to correspond to a subsequent route segment. Thus, in some circumstances the specified average speed can be maintained even when delaying factors exist, for example when the traffic flows slowly now and then. The speed variation curve can in particular be determined continuously, ideally in real time, so that dynamic influences on the speed of the motor vehicle can be taken into account as quickly and as comprehensively as possible. In an embodiment, a maximum average speed can also be specified by the driver so that the speed variation curve is determined in order to ensure a fastest-possible journey.

The method can be used both in traction or part-load operation and also in overdrive operation. Preferably, the method is continuously active, in order to take account of as many external influences as possible on the speed or the acceleration capacity of the motor vehicle in the determination of the speed variation curve.

Advantageously, the method is used in combination with a drive motor whose efficiency differs as a function of its operating point. The operating point can in particular include a rotational speed and/or a torque output. This relationship can also be taken into account as a characteristic by the method in order to determine the speed variation curve.

Thus, on the basis of static data (such as a consumption characteristic of the drive motor or a speed-dependent air resistance) and/or dynamic data (such as the current driving resistance, the current average speed or the flow of traffic), the speed variation curve can be determined in such manner that the driver's wish for a predetermined average speed or an arrival time to be kept to is complied with as much as possible, or even bettered. During this the energy required for the journey is preferably minimized by the method. The driver's wish is also set against the energy consumption since traveling at a higher speed usually involves sharper and/or more frequent accelerations, which can be energy-intensive.

Preferably moreover, a further driver's wish is also detected, such that the speed variation is determined as a function of the further driver's wish either in favor of a higher average speed or in favor of minimized energy consumption. For example the following modes can be implemented: sporty (maximum permitted speed and maximum acceleration over the entire route), standard option (medium average speed and high acceleration), standard (predetermined minimum average speed and average acceleration) and Eco (predetermined minimum average speed and optimum acceleration).

By means of the further driver's wish, the driver can influence whether a speedy journey or an economic operation of the motor vehicle would be most advantageous. These two criteria can be contradictory in relation to determining the speed variation curve. Thus, the degree to which one or the other optimization objective is more markedly weighted can be influenced by the driver.

In one embodiment a specific energy consumption of a drive-train of the motor vehicle depends on an acceleration and a speed of the motor vehicle, and the energy consumption is minimized in that an acceleration is used deliberately to bring the motor vehicle to a speed at which the specific energy consumption is reduced.

In this context the specific energy consumption indicates how much energy is needed in order to operate the motor vehicle at a predetermined operating point for a certain time or with a certain effect. The specific energy consumption in the case of a motor vehicle powered by fossil fuel can be expressed for example in grams of fuel per hour or grams of fuel per kilometer covered. In the case of an electrically powered motor vehicle the specific energy consumption can be expressed in kilowatts per hour or kilowatts per kilometer covered. Other units are also possible. The operating point can for example include a speed, an engaged gear or a rotational speed of a drive motor. If the specific energy consumption required or the travel time is integrated over the route segment, this gives the energy consumption for covering the route segment.

The acceleration is generally positive but can also be negative (deceleration). To bring the motor vehicle from a low to a higher speed, a higher specific energy consumption is usually needed than to maintain a predetermined speed. On the other hand, a specific energy consumption can be lower at a higher speed than at a lower speed.

Preferably, an additional energy consumption caused by the acceleration is set against a lower energy consumption at the higher speed as a function of the distance that can be covered at the higher speed. The end of the distance that can be covered is usually the same as the end of the route segment. Route segments are preferably so determined that along a route segment the motor vehicle can be operated under constant conditions. For example, a route segment may have a uniform speed restriction or a uniform downward gradient, as explained in more detail later. The more sharply the motor vehicle is accelerated, the higher in general is the specific energy consumption during the acceleration phase. If the specific energy consumption during a subsequent phase of constant speed is lower than before the acceleration phase, then the additional energy consumption during the acceleration can be recouped provided that the distance that can be covered at the higher speed is far enough.

In a particularly preferred embodiment, the energy consumption for covering the route segment is first determined with varyingly sharp accelerations and if necessary at various speeds, and that combination of acceleration and speed is preferred, which demands the lowest energy consumption while complying with the average speed specification, That choice can in particular be made on the basis of the above-mentioned further driver's wish. The combination found is then processed further as the speed variation curve.

In another embodiment, a specific energy consumption of a drive-train of the motor vehicle depends on a speed and a gradient of the route segment, and the energy consumption is minimized in that the gradient is covered at a speed at which the specific energy consumption is lower. An acceleration produced by the drive-train can then be small, so that the motor vehicle loses speed.

The gradient is usually positive, but can also be negative (downhill). It can be more favorable to drive downhill at a higher speed, for example in order to gain momentum for a subsequent uphill stretch. However, that usually only applies within predetermined limits, so the speed increase too is preferably also limited. Besides, particularly when accelerating downhill a speed restriction may have to be observed.

In still another embodiment, speed variations for route segments adjacent to one another are determined together. For this, a route segment coming after the current route segment is detected and the speed variations on the route segments are determined together in such manner that the sum of the energy consumptions on the two route segments is minimized as much as possible. For example, during a downhill stretch the speed of the motor vehicle can be increased by a predetermined acceleration, while the speed on a subsequent uphill stretch is gradually reduced. The sum of the energy consumptions can be reduced overall by taking several route segments into account. This consideration of a plurality of route segments can also include several and in particular all the route segments of a predetermined route (overall route).

In a further embodiment, for two route segments adjacent to one another in each case a speed range and a speed variation curve are specified, The speed range can indicate an upper limit and a lower limit for the speed to be adopted by the motor vehicle. If the speed variation curve determined ventures outside these limits, then preferably an automatic adaptation of the speed variation curve of one or more subsequent route segments takes place. For this, the speed range of a subsequent route segment can be changed appropriately. For example, if the speed variation curve along a first route segment fell below the lower limit, then the upper or lower limits of a subsequent route segment can be raised in order to compensate for a time loss on the first route segment. The increase of the upper limit may be restricted by an applicable traffic regulation on the route segment concerned.

In yet another embodiment the drive-train of the motor vehicle comprises a change-speed transmission with a plurality of gear steps. A specific energy consumption then depends on a gear change of an engaged gear step and on the engaged gear step itself. The energy consumption is minimized in that a gear step is changed selectively in order to bring the drive-train to an engaged gear step with a lower specific energy consumption. Similarly to the above-described example with the acceleration and speed of the motor vehicle, in this case too it can again be judged whether an increased consumption due to the change of gear step is likely to be able to be compensated for by the lower specific energy consumption after the gearshift. The single or multiple changing of a gear step can be part of an acceleration or deceleration phase.

In general, several factors influence the specific energy consumption of the motor vehicle. It is therefore preferable to take into account of as many as possible of those factors in order to be able to carry out the speed control in a manner as optimized as possible in relation to consumption.

It is further preferred that the speed variation curve should be determined such that a prescribed maximum speed is not exceeded. In a further preferred embodiment, on the basis of the speed-related driver's wish an upper limit and a lower limit for the average speed of the motor vehicle are determined, and the speed variation curve is determined in such manner that the speed is always between the upper and lower limits so far as possible, By keeping the speed of the motor vehicle within a predetermined range a driver can more clearly get the feeling of a speedy journey. The limits can be input manually or a speed range symmetrical relative to a specified speed can be formed. The upper limit can correspond to locally applicable speed restriction or deviate therefrom by a predetermined amount (such as ±5 km/h or ±2%). In one embodiment an average speed is also determined, for example as the arithmetical mean between the upper limit and the lower limit, and a deviation of the speed of the speed variation curve from the average speed can be minimized or tolerated, for example depending on the above-described further driver's wish.

A computer program product comprises program code means for carrying out the above-described method when the computer program product is run on a processing device or stored on a computer-readable data carrier.

A device comprises an input device for detecting a driver's wish that indicates a desired average speed when driving along a route segment to be covered, a processing device for determining a speed variation curve in accordance with the above-described method, and a control device for controlling the speed of the motor vehicle along the route segment on the basis of the speed variation curve determined.

### BRIEF DESCRIPTION OF THE DRAWINGS

The invention will now be described in more detail with reference to the attached figures, which show:

FIG. 1: A schematic representation of a motor vehicle;

FIG. 2: An example of a specific energy consumption of the motor vehicle shown in FIG. 1; and

FIG. 3: A consumption diagram of the motor vehicle of FIG. 1.

### DETAILED DESCRIPTION OF THE PREFERRED EMBODIMENTS

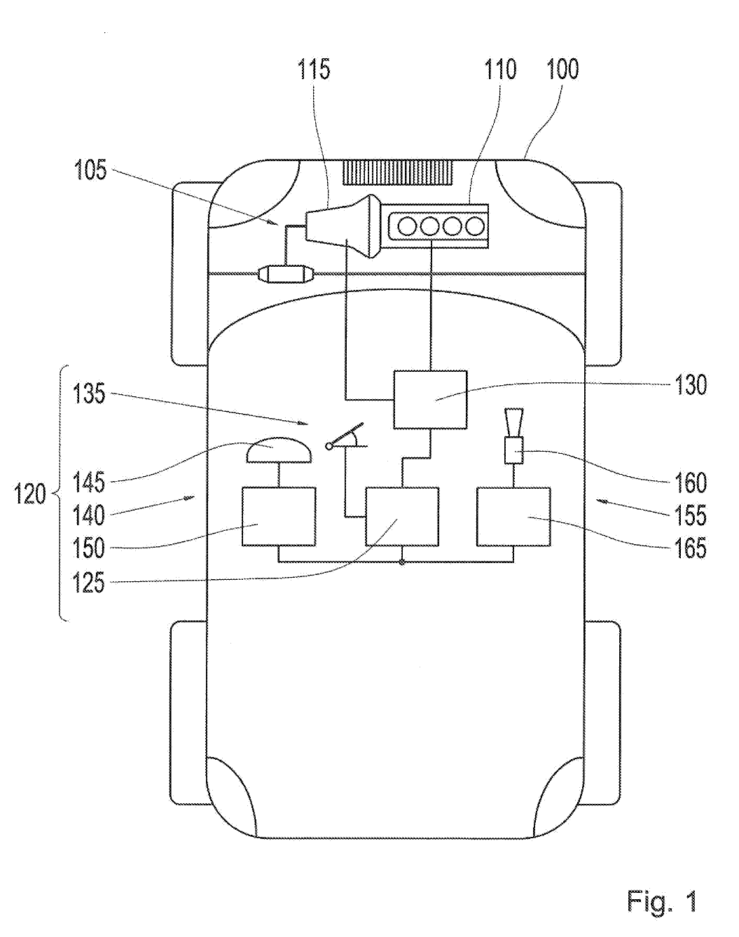

FIG. 1 shows a schematic representation of a motor vehicle 100. The motor vehicle 100 can for example be a passenger car or a truck and is usually powered by a drive-train 105, which converts energy in any form into kinetic energy of the motor vehicle 100. Usually the drive-train 105 comprises a drive motor 110, which for example can be in the form of an electric machine or an internal combustion engine, and a transmission 115, which can in particular comprise a change-speed transmission with several gear steps that can be engaged.

On board the motor vehicle 100, a device 120 for controlling the speed of the motor vehicle 100 is provided. The device 120 usually comprises a processing device 125, which in particular can be in the form of a programmable microcomputer, and a control device 130 for influencing the drive-train 105, in particular the drive motor 110, the transmission 115 and/or a brake system (not shown) of the motor vehicle 100. In addition at least one input device 135 is preferably provided, by means of which a driver of the motor vehicle 100 can express one or more specifications for controlling the speed of the motor vehicle 100. These specifications can in particular include a preferred average speed and if necessary a preference about whether the speed control system should rather favor a lower energy consumption or a higher average speed. The input device 135 can perhaps include a pedal, a switch or some other input means.

The processing device 125 is designed to determine, for a predetermined route which the motor vehicle 100 is to cover, a speed variation curve which takes into account the driver's specifications. For this, the route is usually divided into a sequence of route segments for which in each case the same conditions apply, and which can therefore be covered under constant external conditions in the absence of any situation-related change. In particular a speed restriction, an uphill or downhill gradient, a curve radius or a road category within the route segment can be constant.

The determination of the route and/or the division of the route into route segments can in particular be carried out with the help of data from a navigation system 140, which preferably contains a positioning device 145 for determining a position of the motor vehicle 100 and a databank 150 with route information in the area of the motor vehicle 100. The route can be determined optionally by the navigation system 140 or by the processing device 125. In a further embodiment a scanning system 155 can also be provided, which scans information in the surroundings of the motor vehicle 100 and sends it to the processing device 125, The scanning system 155 preferably comprises a sensor 160 and a recognition device 165. For example, the scanning system 155 can detect a distance to a motor vehicle driving in front, a traffic sign along the route being covered, or some other parameter from the surroundings of the motor vehicle 100 which is relevant for the control of its speed.

The processing device 125 is designed to determine, on the basis of a driver's wish regarding an average speed and a route or route segment to be covered, a speed variation curve which complies with, on the one hand, so far as possible, the driver's specification regarding the average speed and on the other hand minimizes the energy consumption of the motor vehicle 100 as much as possible while it is traveling along the route. Thereafter the processing device 125 can implement the speed variation curve determined by means of the control unit 130, i.e. control the motor vehicle 100 in the longitudinal direction in such manner that on the route or route segment concerned it follows the speed variation curve determined.

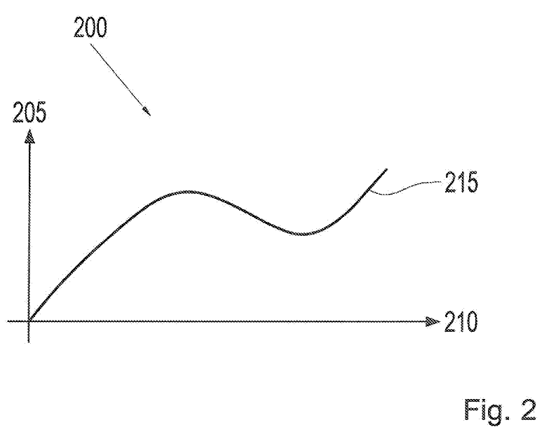

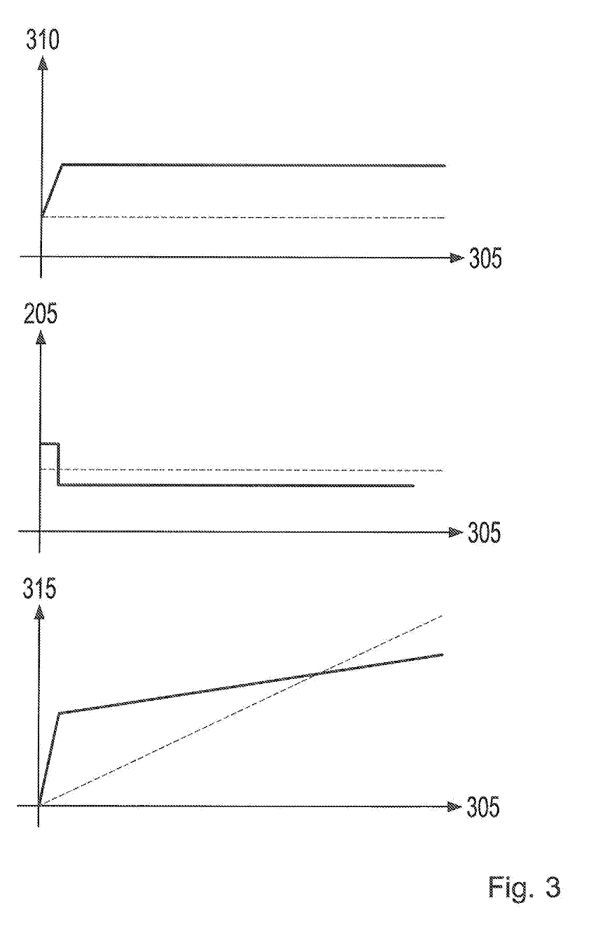

The method worked out for the above purposes will now be described in greater detail with reference to FIGS. 2 and 3 below.

FIG. 2 shows a diagram 200 which illustrates a relationship between a specific energy consumption 205 and some other operating parameter 210, in the form of a variation curve 215.

In a first example the operating parameter 210 concerns a speed of the motor vehicle 100. It can be seen that although the specific energy consumption 205 at first increases as the speed increases it then, however, falls slightly again and then increases once more as the speed increases even more. If the motor vehicle 100—within certain limits—is to be driven both as quickly as possible but also in as energy-saving a manner as possible, then a possibility that suggests itself is to choose a speed at the saddle-point shown. On the other hand, to reach the saddle-point a large amount of energy may have to be spent.

In a second example the relationship illustrated can also apply to the rotational speed of the drive motor 110. The rotational speed usually depends not only on the speed of the motor vehicle 100 but also on a gear step engaged in the transmission 115. However, changing gears can also be an energy-intensive process.

In other examples the operating parameter 210 can also include, for example, a starting speed, an average acceleration, a gear step engaged at the beginning of a route segment, a gear step engaged at the end of a route segment, a number of shifting processes related to the gear step, a starting rotational speed, an average rotational speed, a starting torque, an average torque or a quantity of fuel injected. Parameters such as a vehicle mass or an air resistance value of the motor vehicle can also be taken into account.

FIG. 3 shows a consumption diagram of the motor vehicle 100 of FIG. 1. The horizontal direction represents a route segment 305 and in the vertical direction, from top to bottom, are plotted a speed 310 of the motor vehicle 100, the specific energy consumption 205, and an energy consumption 315. The energy consumption 315 corresponds to an integration of the specific energy consumption 205 over the route segment. For a first example broken lines, and for a second example continuous lines are used in the diagram shown.

In the first example, the motor vehicle 100 drives at constant speed 310. The specific energy consumption 205 is also constant and the energy consumption 315 increases linearly until the end of the route segment 305.

In the second example the motor vehicle 100 is at first accelerated, so its speed 310 increases, and it is then driven at constant speed 310. During the acceleration the specific energy consumption 205 is higher and after the acceleration it is lower than the comparison value from the first example. The energy consumption 315 increases steeply during the acceleration phase and relatively slowly thereafter. When the end of the route segment 305 is reached, the cumulative energy consumption 315 is less in the second example than in the first example.

Whether the investment during acceleration can be recouped depends, among other things, on the length of the route segment 305 still to be covered after the acceleration phase, and on the energy consumption 315 at the end of the acceleration phase. Moreover, pay-back also assumes that after the acceleration phase the specific energy consumption 205 will be lower than before (see FIG. 2).

It is proposed to determine the speed variation curve of the motor vehicle 100 on the basis of various factors each of which influences the specific energy consumption 205. In doing this, in particular various combinations of parameters can be tried in succession in order to find a combination that proves to be the most favorable possible. Bearing in mind the relationship described above with reference to FIG. 2, between a specific energy consumption 205 and another operating parameter 210, an optimized speed variation curve can then be determined.

In a further embodiment pre-calculated and measured values of parameters while driving along a route segment can be compared with one another. A result of the comparison can be stored in order to be able to make a subsequent estimate more accurately. For example, if it emerges that a speed variation curve followed under predetermined conditions has required less energy than expected, then that specific combination of parameters can preferably be used in future. In a similar manner, a negative deviation can be determined and stored in order to avoid a disadvantageous parameter combination in the future. The experiences gained can in particular be stored in a databank. In that way the speed controls can be designed to be self-teaching. On the basis of such stored combinations, for example consecutive route segments can be traveled through with different specifications in order to determine their respective speed variations. A first route segment A could be covered at minimal speed, a subsequent route segment B at maximum speed, and further route segments C and D at an average speed (see above, standard, Eco, etc. modes). The various speeds advantageously relate to an upper limit, a lower limit and an average between the two, and the limits can be specified algorithmically or explicitly, such as on the basis of a driver's wish or a speed restriction.

By virtue of the technique described it is in particular possible to control the speed 310 of the motor vehicle 100 in accordance with a speed assistance system or an autonomous speed control system in such manner that the energy consumption 315 on a route is minimized as much as possible and on the other hand an average speed desired by the driver is exceeded or the route is covered in less time than required. In this, the driver can be allowed the option of setting priorities between the possibly conflicting objectives of reducing energy consumption and traveling quickly, perhaps in the form of a weighting parameter. Furthermore, a speed range can be determined which has an upper limit and a lower limit, between which the speed in the speed variation curve remains.

### INDEXES

100 Motor vehicle
105 Drive-train
110 Drive motor
115 Transmission
120 Device
125 Processing device
130 Control unit
135 Input device
140 Navigation system
145 Positioning device
150 Databank
155 Scanning system
160 Sensor
165 Recognition device
200 Diagram
205 Specific energy consumption
210 Operating parameter
215 Variation curve
305 Route segment
310 Speed
315 Energy consumption

1-10. (canceled)

11. A method of controlling a motor vehicle (100), the method comprising:
identifying a route segment (305) to be covered;
detecting a driver's wish that indicates a desired average speed (310) while traveling along the route segment (305);
determining a speed variation curve (215) for the route segment (305) as a function of the driver's wish in such manner that the average speed (310) corresponds at least to the driver's wish and an energy consumption (315) of the motor vehicle (100), for covering the route segment (305), is minimized as much as possible, and
controlling the speed (310) of the motor vehicle (100) while covering the route segment (305) on a basis of the speed variation curve (215) determined.

12. The method according to claim 11, further comprising detecting a further driver's wish, and determining the speed variation curve (215) as a function of the further driver's wish either in favor of a higher average speed (310) or in favor of minimized energy consumption (315).

13. The method according to claim 11, wherein a specific energy consumption (205) of a drive-train (105) of the motor vehicle (100) depends on an acceleration and a speed (310) of the motor vehicle (100), and the energy consumption (315) is minimized in that an acceleration is selectively used to bring the motor vehicle (100) to a speed (310) at which the specific energy consumption (205) is reduced.

14. The method according to claim 13, wherein an additional energy consumption (315) caused by the acceleration is set against the reduced energy consumption (315) at the higher speed (310), as a function of a distance that can be covered at the higher speed (310).

15. The method according to claim 11, wherein a specific energy consumption (205) of a drive-train (105) of the motor vehicle (100) depends on a speed (310) and a gradient of the route segment (305), and the energy consumption (315) is minimized in that the gradient is covered as far as possible at a speed (310) at which the specific energy consumption (205) is reduced.

16. The method according to claim 11, further comprising identifying a subsequent route segment (305), wherein the speed variation (215) along the route segment (305) and the speed variation (215) along the subsequent route segment (305) are determined together in such manner that a sum of the energy consumptions on the two route segments (305) is minimized as much as possible.

17. The method according to claim 11, wherein a drive-train (105) of the motor vehicle (100) includes a change-speed transmission with a plurality of gear steps, such that a specific energy consumption (205) of the drive-train (105) depends on a change of an engaged gear step and on an engaged gear step, and the energy consumption (315) is minimized in that a gear step is selectively changed in order to bring the drive-train (105) to an engaged gear step in which the specific energy consumption (205) is lower.

18. The method according to claim 11, further comprising determining, based on the speed-related driver's wish, an upper limit and a lower limit for the average speed (310) of the motor vehicle (100), and determining the speed variation curve (215) in such manner that the speed (310), so far as possible, always remains between the upper limit and the lower limit.

19. A computer program product with program code means for carrying out the method according to claim 11, when the computer program product is run on a processing device or stored on a computer-readable data carrier.

20. A device comprising:
an input device (135) for detecting a driver's wish that indicates a desired average speed (310) while traveling along a route segment (305) to be covered;
a processing device (125) for determining a speed variation curve (215) in accordance with a method according to claim 11; and
a control unit (130) for controlling the speed (310) of the motor vehicle (100) along the route segment (305) on the basis of the speed variation curve (215) determined.
